(19) United States
(12) Patent Application Publication
(10) Pub. No.: US 2006/0002560 A1
(43) Pub. Date: Jan. 5, 2006

(54) Radio communication apparatus and radio communication method

(75) Inventor: Shinzo Matsubara, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/168,915

(22) Filed: Jun. 29, 2005

(30) Foreign Application Priority Data
Jun. 30, 2004 (JP) 2004-194680

(51) Int. Cl. H04K 1/00

(52) U.S. Cl. 380/270

(57) ABSTRACT

A radio communication apparatus including a setting unit which sets specific passphrases respectively onto a plurality of terminal identifiers corresponding to a plurality of communication terminal units on a network, a generation unit which respectively generates a plurality of individual keys corresponding to the plurality of terminal identifiers by using the specific passphrases, and transmission/reception units which carry out transmission/reception with respect to one of the plurality of communication terminal units on the network by using the generated individual key corresponding thereto.

### CROSS-REFERENCE TO RELATED APPLICATIONS

This application is based upon and claims the benefit of priority from prior Japanese Patent Application No. 2004-194680, filed Jun. 30, 2004, the entire contents of which are incorporated herein by reference.

### BACKGROUND OF THE INVENTION

1. Field of the Invention

The present invention relates to a radio communication apparatus such as a wireless LAN (local area network) or the like, and in particular, to a radio communication apparatus and a radio communication method in which a passphrase is set onto each communication terminal.

2. Description of the Related Art

Recently, accompanying the diffusion of digital equipments, for example, communication apparatuses such as wireless LAN have come into broad use. In such a radio communication apparatus, for example, a radio communication apparatus in accordance with a communications protocol such as IEEE802.11, and the like have been known.

In the 802.11 specification, Version 2 shown in non-Patent document 1 (WPA for 802.11 Specification, Verion2, Part11: Radio Medium Access Control (MAC) and physical layer (PHY) specifications, Specification for Enhanced Security), for example, as shown in the Frame exchange overview in paragraph 5.9.3.1 on page 13, and in the way handshake analysis in paragraph 8.5.3.7.4 on page 103, when cipher communication is carried out by using a common passphrase without 802.1X authentication being carried out, it is possible for a malicious user to own an individual key in common with an access point if the common passphrase is leaked out, which enables the malicious user to connect to the access point. Further, it is described that, because the individual key is prepared on the basis of the common passphrase and terminal identifier, if a user knows the common passphrase, it is possible for the user to prepare cipher keys of other terminals, which enables the user to tap communications between an access point and a station.

Namely, in this specification serving as a prior art, individual keys used for communication of terminal devices connected to a radio communication apparatus via a network is prepared on the basis of a common passphrase and a terminal identifier, and if the common passphrase is leaked out of one terminal device, it is necessary to change the passphrase in all the terminal devices, which makes the key management extremely troublesome. Further, when the common passphrase is leaked out, the problem that there is the risk that an unjust access is easily achieved to all the terminals of the network is brought about.

### BRIEF SUMMARY OF THE INVENTION

An embodiment of the present invention is a radio communication apparatus comprising: a setting unit which sets specific passphrases respectively onto a plurality of terminal identifiers corresponding to a plurality of communication terminal units on a network; a generation unit which respectively generates a plurality of individual keys corresponding to the plurality of terminal identifiers by using the specific passphrases corresponding to the plurality of terminal identifiers; and transmission/reception units which carry out transmission/reception with respect to one of the plurality of communication terminal units on the network by using the generated individual key corresponding thereto.

### BRIEF DESCRIPTION OF THE SEVERAL VIEWS OF THE DRAWING

FIG. 1 is a block diagram showing an example of a configuration of a radio communication apparatus according to an embodiment of the present invention;

FIG. 2 is a block diagram showing an example of a configuration of a radio transmission processing unit of the radio communication apparatus according to the embodiment of the invention;

FIG. 3 is a block diagram showing an example of a configuration of a medium access control unit of the radio transmission processing unit of the radio communication apparatus according to the embodiment of the invention;

FIG. 4 is a system diagram showing an example of a network for which the radio communication apparatus according to the embodiment of the invention is used;

FIG. 5 is a block diagram showing another example of the configuration of the radio communication apparatus according to the embodiment of the invention;

FIG. 6 is a flowchart showing an example of processing for setting a passphrase to each terminal of the radio communication apparatus according to the embodiment of the invention;

FIG. 7 is a flowchart showing an example of processing for transmitting a group key of the radio communication apparatus according to the embodiment of the invention;

FIG. 8 is a flowchart showing an example of processing for transmitting data by an individual key or a group key of the radio communication apparatus according to the embodiment of the invention;

FIG. 9 is a flowchart showing an example of processing for receiving data by an individual key or a group key of the radio communication apparatus according to the embodiment of the invention; and

FIG. 10 is an explanatory drawing showing an examples of terminal identifies, MAC addresses, passphrases, and the like with which the medium access control unit of the radio communication apparatus according to the embodiment of the invention deals.

### DETAILED DESCRIPTION OF THE INVENTION

Hereinafter, an embodiment of the present invention will be described in detail with reference to the drawings.

In a radio communication apparatus according to the embodiment of the invention, at least a passphrase for each communication terminal is set, and transmission and reception are carried out by using an individual key (cipher key) generated in accordance with the passphrase (S32).

For example, by using a wireless LAN relay apparatus connected to a plurality of notebook model personal computers as an example, the principle of operations of the radio communication apparatus according to the embodiment of the invention is described. However, it goes without saying that the radio communication apparatus according to the embodiment of the invention is not limited to this example.

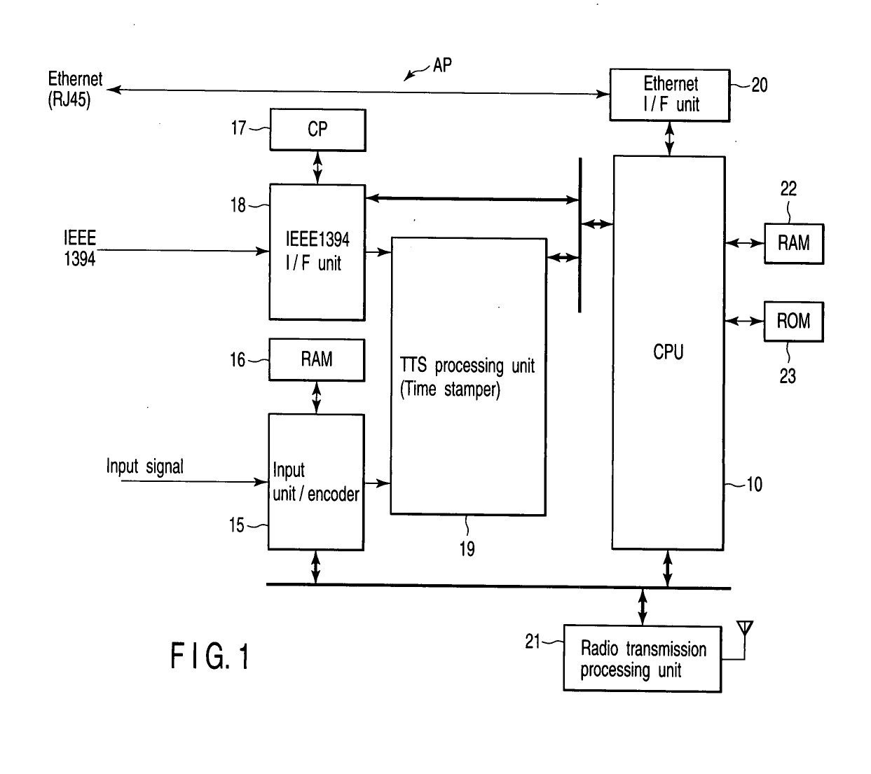

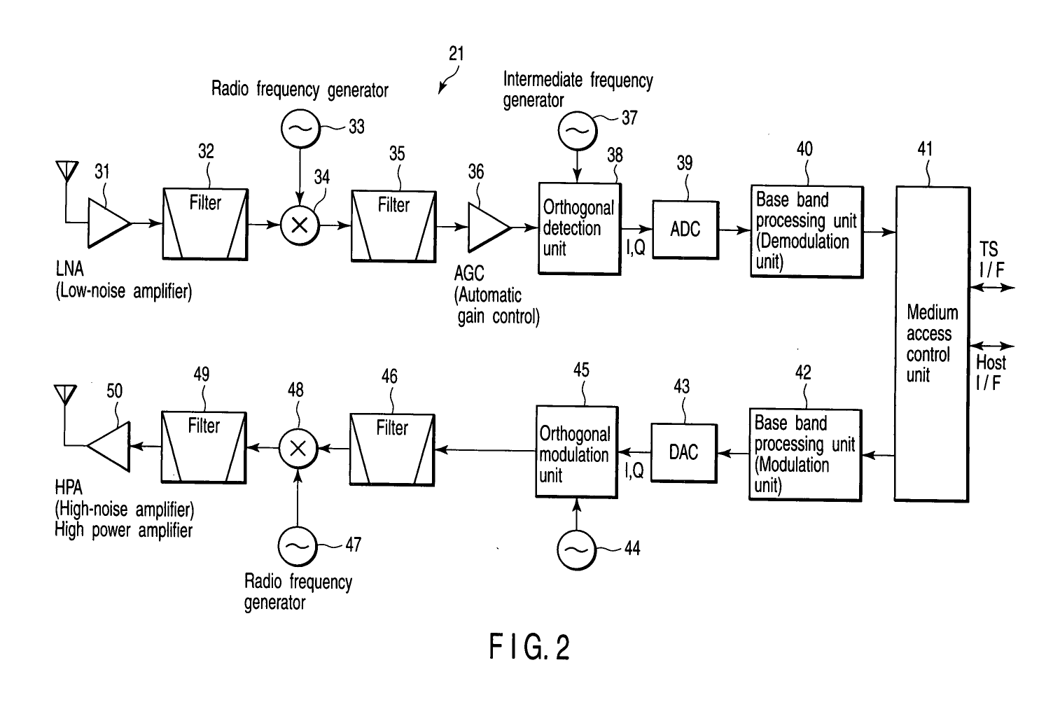

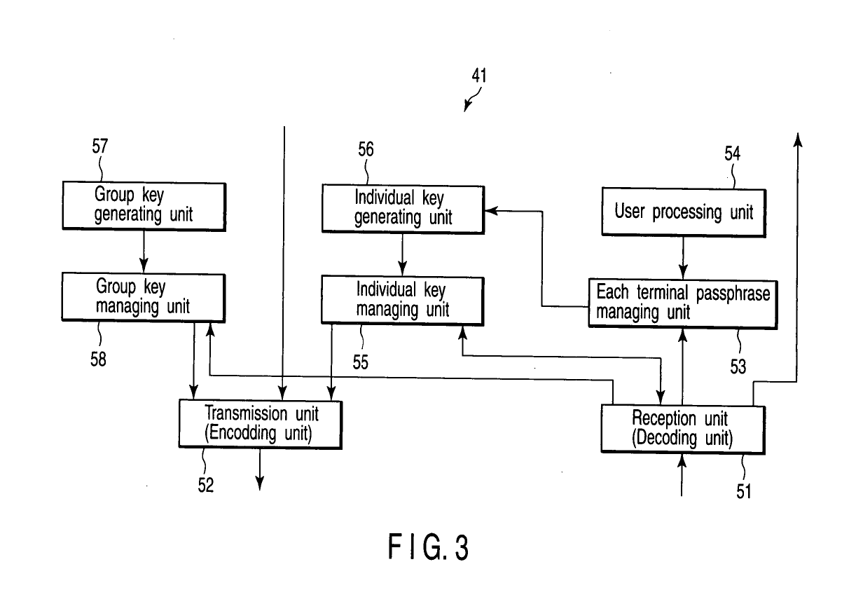

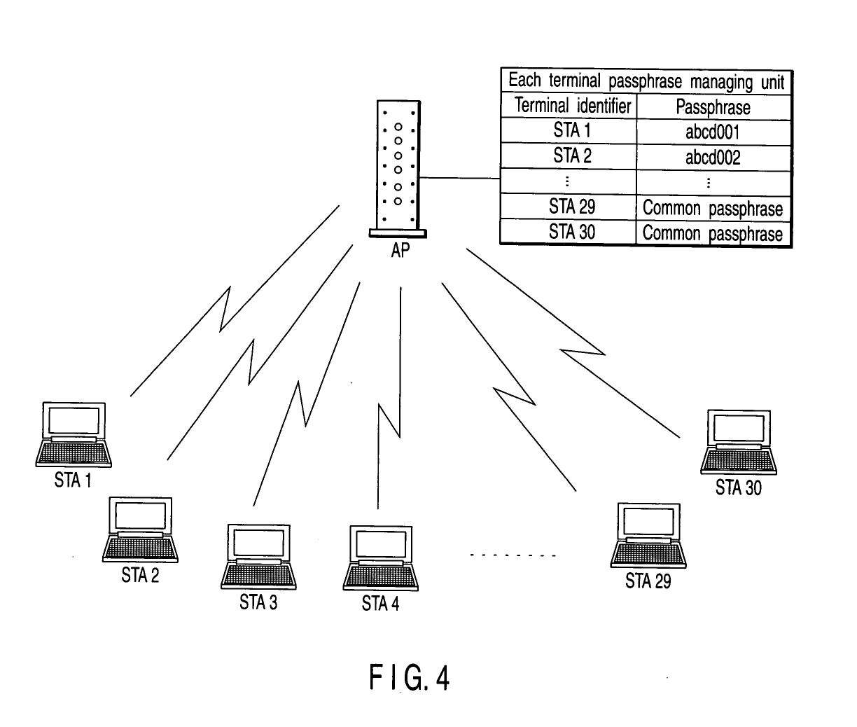

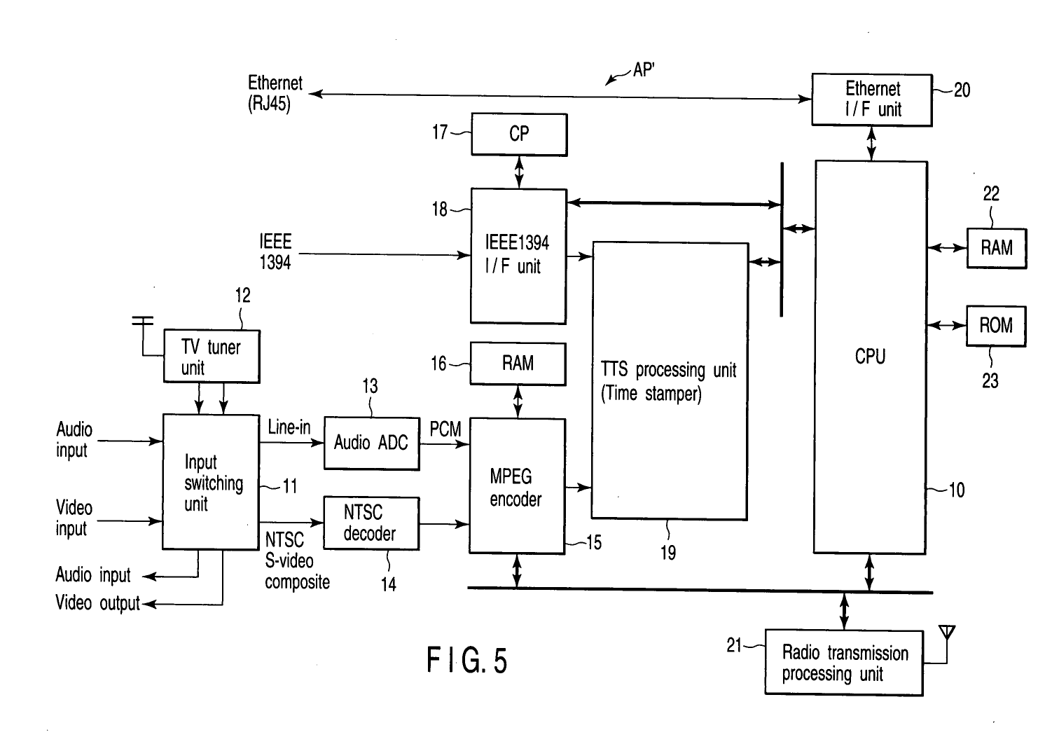

FIG. 1 is a block diagram showing an example of a configuration of the radio communication apparatus according to the embodiment of the invention, FIG. 2 is a block diagram showing an example of a configuration of a radio transmission processing unit, FIG. 3 is a block diagram showing an example of a configuration of a medium access control unit of the radio transmission processing unit, FIG. 4 is a system diagram showing an example of a network for which the radio communication apparatus is used, and FIG. 5 is a block diagram showing another example of the configuration of the radio communication apparatus.

<Radio Communication Apparatus according to the Embodiment of the Invention>

(Configuration)

An example of the configuration of the radio communication apparatus according to the embodiment of the invention will be described with reference to the drawings. A radio communication apparatus AP is one at least to transmit predetermined information such as, for example, text information, picture information, and contents information, to communication terminal units STA.

The radio communication apparatus AP serving as the embodiment of the invention has a CPU 10 managing the control of the entire apparatus, a RAM 22 and a ROM 23 connected to the CPU 10 via data buses, an input unit/encoder 15, a RAM 16 connected to the input unit/encoder 15, and a TTS (time stamper) processing unit 19 which is connected to data buses, and which matches timings of respective signals at the time of communication. Further, the radio communication apparatus AP is connected to a data bus, and has an Ethernet I/F unit 20 for carrying out communication in accordance with an Ethernet protocol, an IEEE1394 I/F unit 18 for carrying out communication in accordance with an IEEE1394 protocol, a copyright protection unit 17 connected to the IEEE1394 I/F unit 18, and moreover, a radio transmission processing unit 21 for carrying out radio communication in accordance with a radio protocol such as, for example, an IEEE802.11i (not limited to this protocol).

As shown in FIG. 2, the radio transmission processing unit 21 further has, as a configuration for receiving processing, a low-noise amplifier 31 for receiving radio signals via an antenna from the exterior, a filter 32 connected to the low-noise amplifier 31, an adder 34 which receives output of the filter 32 and receives output of a radio frequency generator 33, a filter 35 for receiving output of the adder 34, and an automatic gain control unit 36 for automatically controlling a gain by receiving an output from the filter 35. Moreover, the radio transmission processing unit 21 has an orthogonal detection unit 38 which receives output of the automatic gain control unit 36, and which receive output of an intermediate frequency generator 37, an A/D conversion unit 39 which analog-to-digital converts the output, a base band processing unit (demodulation unit) 40 for demodulating the output, and a medium access control unit 41 which receives the output to coordinate processings for communicating with respective media. Moreover, the radio transmission processing unit 21 has, as a configuration for transmitting processing, a base band processing unit (modulation unit) 42 for receiving output of the medium access control unit 41, a D/A converter 43 for carrying out digital-to-analog conversion by receiving the output, and an orthogonal conversion unit 45 for receiving the output and output of an intermediate frequency generator 44. Moreover, the radio transmission processing unit 21 has a filter 46 for receiving output from the orthogonal conversion unit 45, an adder 48 adding output of the filter 46 and output of a radio frequency generator 47, a filter 49 for receiving the output, and a high-power amplifier 50 for amplifying a radio signal by receiving an output of the filter 49, and is one to output the amplified radio signal.

The basic configuration of communication terminal units STA1 to STA30 serving as communication partners for the radio transmission apparatus AP has a configuration same as the radio communication apparatus AP shown in FIG. 1. However, the medium access control unit 41 of the radio transmission processing unit 21 has no specific key managing function as in FIG. 3 which will be described later.

(Other Configurations of Radio Communication Apparatus)

The radio communication apparatus serving as the embodiment of the invention is not limited to the case of FIG. 1, and can have other configurations. As an example of the configurations, as shown in FIG. 5, the radio communication apparatus AP′ has a CPU 10 for managing the control of the entire apparatus, a RAM 22 and a ROM 23 connected to the CPU 10 via data buses, an input switching unit 25 which receives audio input and video input, and audio input due to a hard disk recorder or the like being connected, and moreover, which outputs audio output and vide output due to a TV tuner unit 24 being connected, an audio DA converter 26 for carrying out digital-to-analog conversion of audio signals due to Line-In being supplied from the input switching unit 25, an NTSC decoder 27′ for supplying NTSC video, S-video, composite video, and the like from the input switching unit 25, and moreover, an MPEG encoder 15′ which receives output of the audio DA converter 26′ and the NTSC decoder 27′, and which converts the output into MPEG data, the RAM 16 connected to the MPEG encoder 15′, and the TTS (time stamper) processing unit 19 which is connected to data buses, and which matches timings of respective signals at the time of communication.

(Key Managing Function of Medium Access Control Unit of Radio Transmission Processing Unit of Radio Communication Apparatus)

The key managing function of the radio communication apparatus serving as the embodiment of the invention is achieved by the configuration of the medium access control unit 41, and FIG. 3 shows an example of the configuration of the medium access control unit 41. Namely, in FIG. 3, the medium access control unit 41 has a reception unit (decoding unit) 51, a transmission unit (encoding unit) 52, and moreover, a user processing unit 54 for receiving a request from a user, an each terminal passphrase managing unit 53 for setting a passphrase onto each communication terminal, an individual key generating unit 56, an individual key managing unit 55, a group key generating unit 57 for generating a group key, and a group key managing unit 58.

(Configuration Example of Communication System of Radio Communication Apparatus)

A configuration example of a communication system formed by the radio communication apparatus AP according to the present invention will be described with reference to FIG. 4. In FIG. 4, although the radio communication apparatus AP can configure various communication systems, here, the example in which the radio communication apparatus AP is constituted as a radio relay apparatus in such a manner that the communication terminal units STA1 to STA30 such as IC cards are respectively built into about thirty notebook model personal computers in a office will be described.

As will be described later, with respect to twenty notebook model personal computers among the thirty notebook model personal computers, registration by a passphrase for each terminal to which a group key is provided is carried out, and with respect to the remaining ten notebook model personal computers, registration by a common passphrase to which a non-registered group key is provided is carried out. After carrying out the registration, for example, communication is possible between the respective notebook model personal computers STA1 to STA20 and the radio communication apparatus AP by a protocol according to, for example, a communications protocol of IEEE802.11x. Further, even among the notebook model personal computers STA21 to STA30 in which registration by a passphrase for each terminal is not carried out and the radio communication apparatus AP as well, communication is possible in the same way. Further, among the respective notebook model personal computers STA1 to STA30 as well, communication is made possible by using the radio communication apparatus AP as a radio relay apparatus.

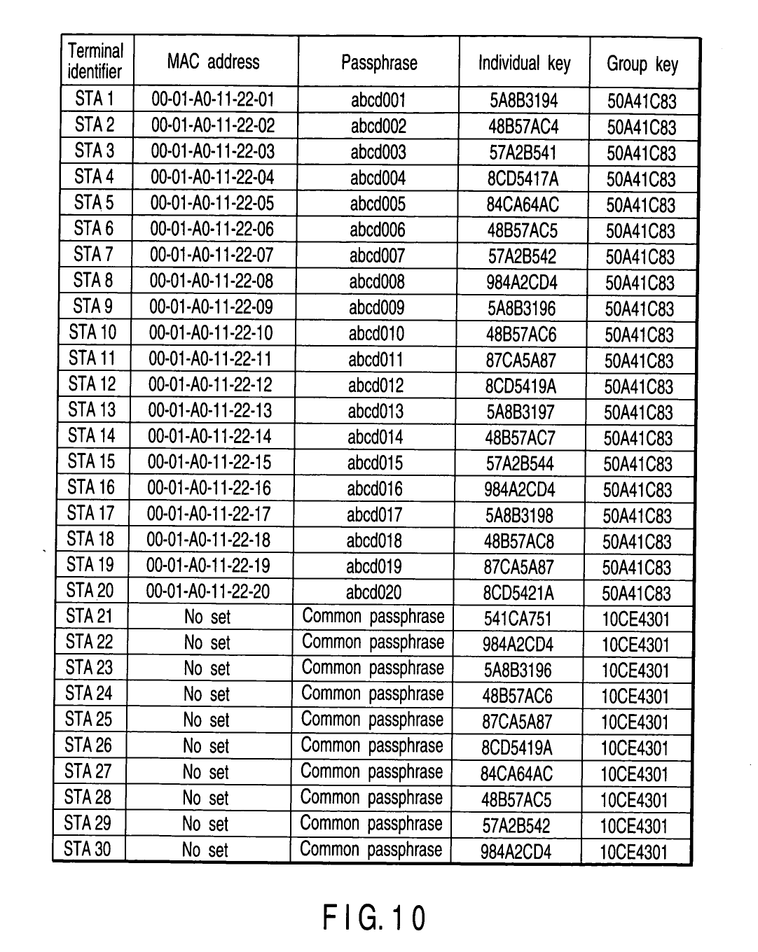

As in the explanatory drawing of FIG. 10, an example of terminal identifiers, MAC addresses, passphrases, individual keys, and group keys in the respective notebook model personal computers are shown. The example of the data will be further described later in a description of a key managing method with a flowchart.

<Key Managing Method of Radio Communication Apparatus serving as the embodiment of the invention>

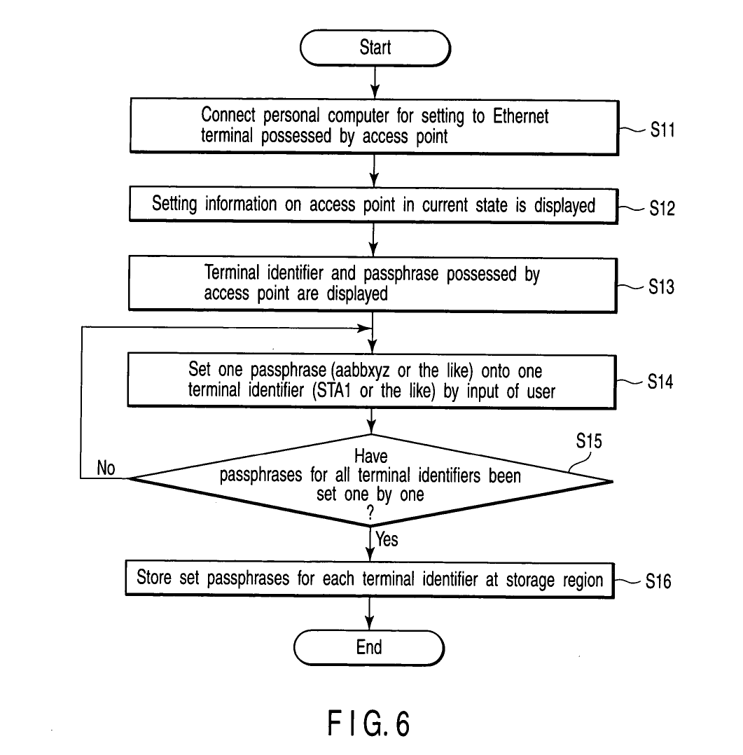

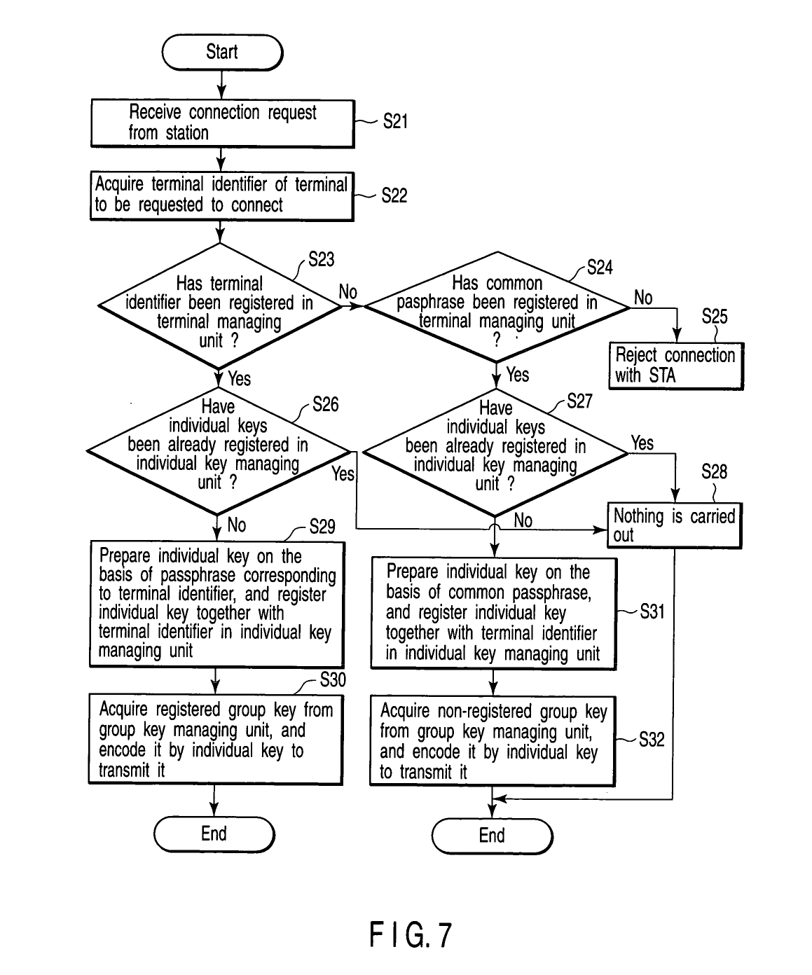

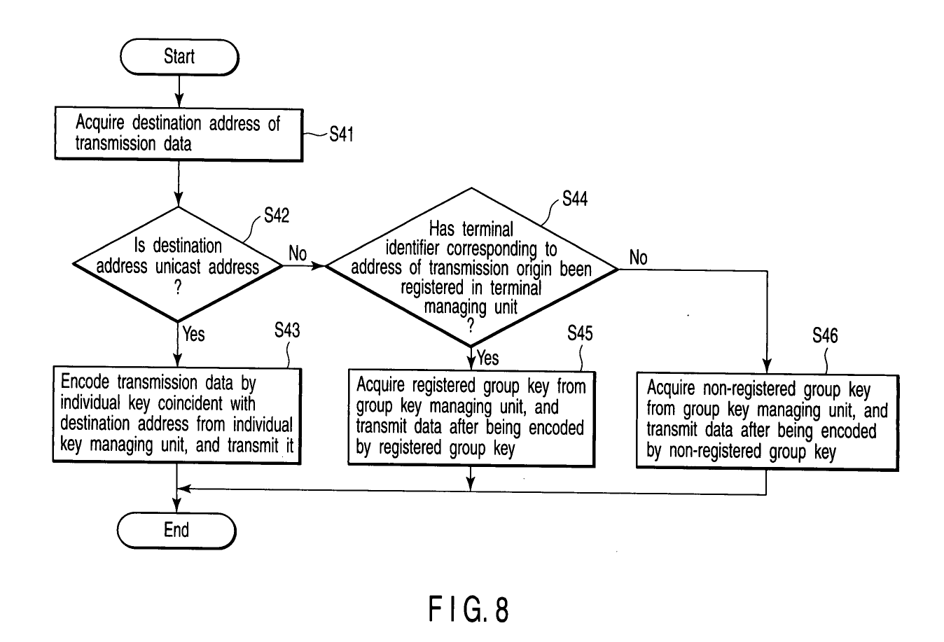

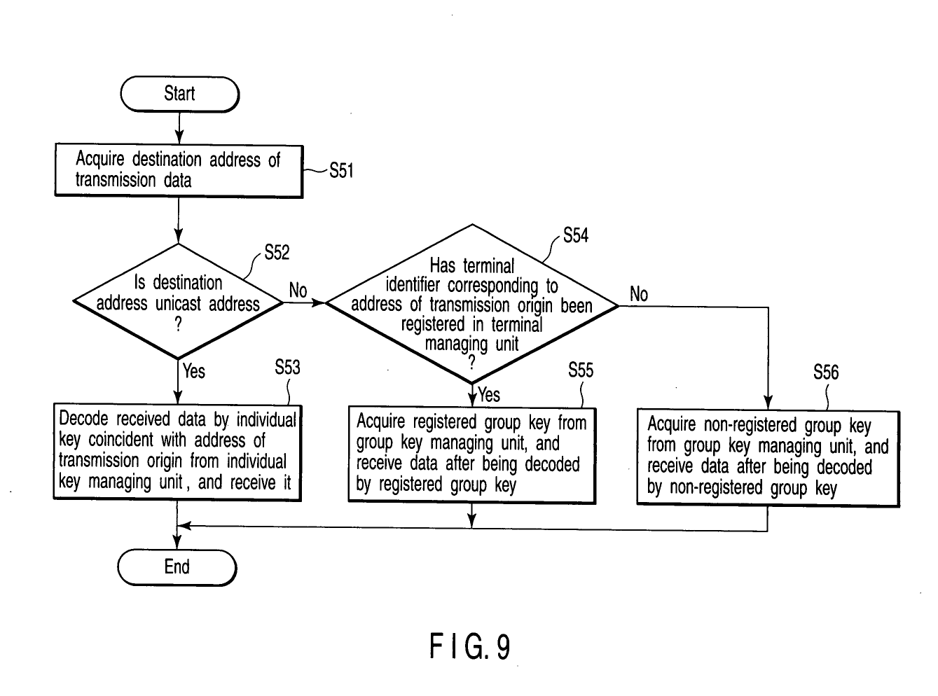

A key managing method of the radio communication apparatus serving as the embodiment of the invention will be described in detail hereinafter with reference to the drawings. FIG. 6 is a flowchart showing an example of processing for setting a passphrase to each terminal of the radio communication apparatus according to the embodiment of the invention, FIG. 7 is a flowchart showing an example of processing for transmitting a group key of the radio communication apparatus, FIG. 8 is a flowchart showing an example of processing for transmitting data by an individual key or a group key of the radio communication apparatus, FIG. 9 is a flowchart showing an example of processing for receiving data by an individual key or a group key of the radio communication apparatus, and FIG. 10 is an explanatory drawing showing an example of terminal identifiers, MAC addresses, passphrases, and the like with which the medium access control unit of the radio communication apparatus deals.

(Processing for Setting Passphrases onto each Terminal identifier)

Processing for setting a passphrase onto each terminal identifier will be described with reference to FIG. 6. A network administrator connects a notebook model personal computer for setting, or the like, for example, to the Ethernet I/F unit 20 of the radio communication apparatus AP (S11). However, setting of a passphrase onto each terminal identifier is not necessarily limited to this method, and may be carried out so as to input setting information to the radio communication apparatus AP by some method. The current setting information of the radio communication apparatus AP is displayed on a screen of the connected notebook model personal computer (S12). On the setting screen, a terminal identifier and a passphrase which the radio communication apparatus AP has are displayed (S13).

A predetermined passphrase is provided as an initial value to each identifier. However, the network administrator can input an arbitrary password, for example, “abcd001” from the notebook model personal computer for setting or the like so as to correspond to each terminal identifier one by one (S14). FIG. 10 is an explanatory drawing for showing a concrete example thereof.

In FIG. 10, the STA1 to STA30 are provided as terminal identifiers. The terminal identifies at this time may be, for example, MAC addresses as shown in FIG. 10, and the MAC address are specific address values respectively provided in advance to the communication terminal units which are installed in the respective notebook model personal computers and which have radio communication functions.

In FIG. 10, it has been known that, alphabets and numerals of 7 letters to 63 letters or the like are used as the passphrases, and as the individual keys and the group keys (or non-registered group keys), for example, hexadecimal of 32 digits are used. However, it is possible to execute by any numeric value or any mark. Further, as will be described later, the individual keys can be generated by arithmetic processing in accordance with a predetermined function between a passphrase and a terminal identifier. However, the individual keys may be generated by another processing.

When the network administrator thinks that specific passphrases are set onto all the necessary terminal identifiers one by one, the setting operation is completed here, and the passphrases for each terminal identifier which have been set are stored in, for example, a storage region of the each terminal passphrase managing unit 53 (S16).

(Processing for Setting Group Keys)

A method for setting a group key will be described hereinafter. The group key generating unit 57 generates registered group keys which terminals registered in the each terminal passphrase managing unit 53 use, and non-registered group keys which terminals which have not been registered in the each terminal passphrase managing unit 53 use, and registers those in the group key managing unit 58. The group keys may be generated at the time of initializing the system, or at the time of requesting to connect the terminals registered in the each terminal passphrase managing unit 53 and when the registered group keys have not been registered in the group key managing unit 58, or may be generated at each time of requesting to connect a terminal. Note that the non-registered group keys may be generated at the group key generating unit 57 at the same timing, and can be registered in the group key managing unit 58.

Processing for generating an individual key (cipher key) and processing for transmitting group keys/non-registered group keys at the radio communication apparatus AP will be describe with reference to the flowchart of FIG. 7. In the system diagram of the network sampled in FIG. 4, in a state in which the radio communication apparatus AP has been started, when the radio communication apparatus AP receives a connection request at the reception unit 51 from one of the stations STA1 to STA30 serving as communication terminal units connected to, for example, notebook model personal computers (S21), a terminal identifier of a terminal unit to which the connection request has been requested is acquired (S22). Then, the reception unit 51 determines whether or not the information on the transmission origin and the terminal identifier registered in the each terminal passphrase managing unit 53 are coincident with one another (S23), and when those are coincident with one another, the transmission unit 52 determines whether or not the individual key managing unit 55 has already registered an individual key corresponding to the terminal unit which has carried out the connection request (S26), and when the individual key has been registered therewith, nothing is carried out (S28).

When the individual key has not been registered therewith (S26), an individual key is generated on the basis of a passphrase corresponding to the terminal identifier (S29), and the individual key is registered together with the terminal identifier in the individual key managing unit 55 (S29). Then, a registered group key managed at the group key managing unit 58 is transmitted to the corresponding communication terminal unit via the transmission unit 52 (S30).

When the terminal identifier of the transmission origin which has requested for connection has not been registered in the each terminal passphrase managing unit 53 (S23), if a common passphrase has been registered in the each terminal passphrase managing unit 53 (S24), in a case in which the individual key has not been registered in the individual key managing unit 56 (S27), an individual key is prepared by using the common passphrase, and the individual key is registered together with the terminal identifier in the individual key managing unit 55 (S31). Then, a non-registered group key managed at the group key managing unit 58 is transmitted to a corresponding communication terminal unit via the transmission unit 52. At that time, the transmission unit 52 acquires the individual key from the individual key managing unit 55, and transmits to encode the registered group key by the individual key.

Note that, when a common passphrase does not exist at step S24, the connection with a communication terminal unit is rejected (S25). Further, when the individual key has been already registered by the individual key managing unit 55 at step S27, the processing is not carried out.

In this way, in the radio communication apparatus AP, with respect to the registered terminal identifier and the non-registered terminal identifier, the respective individual keys (cipher keys) are processed to be registered, and moreover, the group keys and the non-registered group keys are encoded by these individual keys, and are transmitted to the respective terminal units.

(Processing for Transmission by Using Individual Keys)

Processing for transmitting data by using the individual keys generated in this way in the radio communication apparatus AP will be described by using the flowchart of FIG. 8.

The transmission unit 52 of the radio communication apparatus AP receives a request to transmit data from the respective communication terminal units STA1 through STA30, and acquires a destination address (S41). It is identified whether the destination address is a unicast address or a multicast address (S42), and when the destination address is a unicast address, desired transmission data is encoded by an individual key coincident with the destination address from the individual key managing unit 55, and is transmitted to corresponding respective communication terminal units STA (S43).

When the destination address is a multicast address (S42), a terminal identifier corresponding to the address of the transmission origin has been registered in the terminal managing unit, and when the destination information uses the registered group keys (S44), the data is encoded by using the registered group keys registered in the group key managing unit 58, and is transmitted (S45).

When the destination information uses the non-registered group keys (S44), the data is encoded by using the non-registered group keys registered in the group key managing unit 58, and is transmitted (S45). The destination information and the determination on the use of the registered group keys/the non-registered group keys are made to correspond to one another by a multicast address.

(Processing for Reception by Using Individual Keys)

Processing for receiving data by using individual keys generated in this way in the radio communication apparatus AP will be described by using the flowchart of FIG. 9.

When the reception unit 51 of the radio communication apparatus AP receives data from the respective communication terminal units STA1 through STA30, a destination address of the received data is acquired (S51). It is identified whether the data is a unicast address or a multicast address on the basis of the destination information (S52). When the destination address is a unicast address, the received data is decoded and reproduced by using an individual key coincident with the address of the transmission origin from the individual key managing unit 55 (S53).

When the destination address is a multicast data, it is investigated whether or not a terminal identifier corresponding to the address of the transmission origin has been registered in the each terminal passphrase managing unit 53 (S54). When the terminal identifier has been registered therewith, the data is decoded and reproduced by the registered group key registered in the group key managing unit 58 (S55).

When a terminal identifier has not been registered, a non-registered group key is acquired by the group key managing unit 58, and the data is decoded and reproduced by using the non-registered group key (S56).

When the common passphrase is leaked out by producing the received data in this way, encoding of the multicast communication is made meaningless. However, by using another group key among the registered terminals, it is possible to improve the security for the leakage of the common passphrase.

(Processing for Updating Passphrases)

Processing for updating passphrases will be described. When the user processing unit 54 receives a request to set a passphrase so as to designate a terminal identifier from a user, it is investigated whether or not a passphrase of the corresponding terminal identifier has been already registered in the each terminal passphrase managing unit 53. When the passphrase has been already registered, the passphrase already registered in the each terminal passphrase managing unit 53 is updated. Further, when an individual key of the corresponding terminal identifier has been registered in the individual key managing unit 55, the individual key and the terminal identifier are deleted. Or, only the information on the key may be deleted with the terminal identifier being as is. Then, when the radio communication apparatus AP receives a connection request from a station at the reception unit 51, the generation and management of individual keys, and the procedure of transmitting the group keys are carried out in accordance with the same procedure, and it is possible to carry out cipher communication using the individual keys and the group keys.

When individual keys are generated at the terminals registered in the each terminal passphrase managing unit 53, group keys are generated again at the group key generating unit 57, and the group keys are distributed again to the registered terminals.

As describe above, in the radio communication apparatus described above, the individual keys (cipher keys) are not generated by uniformly using a common passphrase with respect to many radio terminal devices on the network as in the prior art. In the radio communication apparatus described above, passphrases specific to the respective communication terminals are respectively set. Therefore, even when a passphrase is leaked out to a third party, it is sufficient to replace only the passphrase of a communication terminal which has been leaked out, and the damage of the leakage can be kept to less extent. In accordance therewith, the management of the passphrases is made easy, and it is possible to provide a radio communication apparatus of a high security network.

In accordance with the various embodiments described above, the skilled in the art can realize the present invention. However, it is easy for those skilled in the art to further conceive of various modified examples of these embodiments, and the present invention can be applied to various embodiments without inventive ability. Accordingly, the present invention extends over a broad range which does not contradict the disclosed principles and the novel features, and is not limited to the embodiments described above.

What is claimed is:

1. A radio communication apparatus comprising:
a setting unit which sets specific passphrases respectively onto a plurality of terminal identifiers corresponding to a plurality of communication terminal units on a network;
a generation unit which respectively generates a plurality of individual keys corresponding to said plurality of terminal identifiers by using the specific passphrases corresponding to said plurality of terminal identifiers; and
transmission/reception units which carry out transmission/reception with respect to one of said plurality of communication terminal units on the network by using the generated individual key corresponding thereto.

2. The radio communication apparatus according to claim 1, wherein the setting unit sets MAC addresses and passphrases which are specific to communication terminal units at said each communication terminal unit.

3. The radio communication apparatus according to claim 1, wherein the setting unit carries out setting by inputting a specific passphrase so as to correspond to a terminal identifier specific to said each communication terminal unit in accordance with an operation of a user of a personal computer connected to an Ethernet.

4. The radio communication apparatus according to claim 1, further comprises a group key managing unit which, when the setting unit has set a specific terminal identifier and a specific passphrase at said each communication terminal unit, encodes a group key serving as key data by an individual key of a communication terminal unit generated at the generation unit, and transmits it to the communication terminal unit.

5. The radio communication apparatus according to claim 1, wherein, the group key managing unit which, when the specific passphrase set at the setting unit has been changed, generates a new individual key on the basis of the changed specific passphrase, and generates a new group key, and encodes the new group key by the generated new individual key to transmit it to the communication terminal unit.

6. The radio communication apparatus according to claim 1, wherein, when the setting unit has not set the passphrase for said each communication terminal unit, individual keys are generated on the basis of a common passphrase prepared in advance, and a non-registered group key serving as key data different from the group key data is encoded by the individual keys, and is transmitted to the communication terminal unit.

7. The radio communication apparatus according to claim 1, wherein, when a signal is supplied from one of the communication terminal units on the network, the transmission/reception unit encodes and reproduces the signal by the individual key corresponding to the communication terminal unit, and when there is a transmission request to one of the communication terminal units on the network, the transmission/reception unit encodes a signal to be transmitted by the individual key corresponding to the communication terminal unit, and transmits the encoded signal to the communication terminal unit.

8. The radio communication apparatus according to claim 1, wherein the transmission/reception unit carries out transmission/reception with respect to, not only the communication terminals at which the terminal identifiers and the passphrases have been set at the setting unit, but also the communication terminals at which the terminal identifier and the passphrase are not set.

9. The radio communication apparatus according to claim 1, wherein the transmission/reception unit carries out transmission/reception with respect to all the communication terminals on the network by using both of the group key set onto the communication terminals at which the terminal identifiers and the passphrases have been set at the setting unit, and the non-registered group key set onto the communication terminals at which the terminal identifier and the passphrase are not set.

10. A radio communication apparatus comprising:
a setting unit which sets specific passphrases respectively onto a plurality of terminal identifiers corresponding to a plurality of communication terminal units on a network;
a generation unit which respectively generates a plurality of individual keys corresponding to said plurality of terminal identifiers by using the specific passphrases corresponding to said plurality of terminal identifiers;
transmission/reception units which carry out transmission/reception with respect to one of said plurality of communication terminal units on the network by using the generated individual key corresponding thereto; and
an individual key managing unit which, when a terminal identifier of one of said plurality of communication terminal units of which the transmission/reception unit has newly received a connection request has not been set at the setting unit, generates an individual key by using a common passphrase, and registers it together in the terminal identifier.

11. A radio communication method comprising:
setting specific passphrases respectively onto a plurality of terminal identifiers corresponding to a plurality of communication terminal units on a network;
respectively generating a plurality of individual keys corresponding to said plurality of terminal identifiers by using the specific passphrases corresponding to said plurality of terminal identifiers; and
carrying out transmission/reception with respect to one of said plurality of communication terminal units on the network by using the generated individual key corresponding thereto.

12. The radio communication method according to claim 11, wherein MAC addresses and passphrases which are specific to the communication terminal units are set onto each communication terminal unit.

13. The radio communication method according to claim 11, wherein setting is carried out by inputting a specific passphrase so as to correspond to a terminal identifier specific to said each communication terminal unit in accordance with an operation of a user of a personal computer connected to an Ethernet.

14. The radio communication method according to claim 11, wherein, when specific terminal identifiers and specific passphrases are set onto said each communication terminal unit, a group key serving as key data is encoded by the generated individual key of a communication terminal unit, and is transmitted to the communication terminal unit.

15. The radio communication method according to claim 14, wherein, when the set specific passphrase has been changed, a new individual key is generated on the basis of the changed passphrase, and a new group key is generated, and is encoded by the generated new individual key and transmitted to the communication terminal unit.

16. The radio communication method according to claim 11, wherein, when the passphrase has not been set, an individual key is generated on the basis of a common passphrase prepared in advance, and a non-registered group key serving as key data different from the group key data is encoded by the individual keys, and is transmitted to the communication terminal unit.

17. The radio communication method according to claim 11, wherein, when a signal is supplied from one of the communication terminal units on the network, the signal is encoded and reproduced by the individual key corresponding to the communication terminal unit, and when there is a transmission request to one of the communication terminal units on the network, a signal to be transmitted is encoded by the individual key corresponding to the communication terminal unit, and the encoded signal is transmitted to the communication terminal unit.

18. The radio communication method according to claim 11, wherein the transmission/reception_is carried out with respect to, not only the communication terminals at which the terminal identifier and the passphrase have been set, but also the communication terminals at which the terminal identifier and the passphrase are not set.

19. The radio communication method according to claim 11, wherein the transmission/reception_carries out transmission/reception with respect to all the communication terminals on the network by using both of the group key set onto the communication terminals at which the terminal identifier and the passphrase have been set, and the non-registered group key set onto the communication terminals at which the terminal identifier and the passphrase are not set.
